(19) United States
(12) Patent Application Publication
(10) Pub. No.: US 2007/0088901 A1
(43) Pub. Date: Apr. 19, 2007

(54) Informative display on a data storage device

(76) Inventors: David Norton Skinner, Redwood Shores, CA (US); Yancy Chen, Campbell, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,563

(22) Filed: Oct. 13, 2005

(51) Int. Cl. G06F 12/00

(52) U.S. Cl. 711/100

(57) ABSTRACT

A display device for displaying information related to the contents of a storage device is presented. The display device has a housing, which houses a data storage element and a display element. The display element is coupled to a memory unit, which stores the information related to the contents of the storage device. The housing also houses a port, which is configured to communicatively couple with a host system.

### TECHNICAL FIELD

Embodiments of the present invention relate to methods and devices to display information related to the contents of a digital media storage device upon an attached display.

### BACKGROUND ART

Consumers have rapidly adopted digital media in every available form. Digital music, digital photographs, and digital video have quickly become mainstream, and the attendant technologies are part of a massive market in consumer electronics. Digital media has given consumers greater control over their media than has ever been possible before. Rapid improvements in the capacity of storage devices, as well as a diversification in the types of devices available for storage, have allowed consumers to generate and collect more media than ever. The problem is in keeping all of this stored information readily accessible.

Consumers have faced this problem before. Recordings on audio and video cassettes have long presented a similar issue: once information has been recorded onto a blank tape, the tape needs to be identified in some way. If a user cannot find the tape they wish to watch or listen to, there is no value in having a recording at all. The traditional approach is to apply an adhesive label to the tape, or place the tape in a case with a label. Most video and audio cassettes have a low enough capacity that fitting a sufficient description of the contents on the label is possible.

Written labels were not ideal, even for this usage. Upon occasion, more would be recorded on a blank tape than could be adequately described on a written label. Frequently, the contents of the tape would change, invalidating the current label and requiring a new one. And all too often, the user would not bother to promptly label recordings. Whenever the labeling system failed, the user would need to laboriously insert every tape that might contain the desired information into the appropriate player, and move through the contents until he or she found what they were looking for.

Digital media storage devices exacerbate this problem. Users still store their information on rewritable media, but the quantity of information that can be stored is much greater than the 8 hours of video available on the largest of VHS cassettes. A Compact Flash card might store hundreds or thousands of digital photographs; a hard disk drive (HDD) has the capacity for over a hundred hours of high-quality digital videos. If the user lacks detailed information about the full contents of each of his storage devices, he will have to wade through gigabytes of information to find any specific file.

As the cost of these storage devices continues to decrease, and the technologies they are used in become more pervasive, the consumer is faced with the unwelcome task of having to keep constant track of the contents of hundreds or thousands of gigabytes of storage. An adhesive paper label stuck to the outside of an HDD is a poor solution.

### DISCLOSURE OF THE INVENTION

A display device for displaying information related to the contents of a storage device is presented. The display device has a housing, which houses a data storage element and a display element. The display element is coupled to a memory unit, which stores the information related to the contents of the storage device. The housing also houses a port, which is configured to communicatively couple with a host system.

### BRIEF DESCRIPTION OF THE DRAWINGS

The drawings referred to in this description should not be understood as being drawn to scale unless specifically noted. The accompanying drawings, which are incorporated in and form a part of this specification, illustrate embodiments of the invention and, together with the description, serve to explain the principles of the invention:

FIG. 1A is a representation of a storage device with an integrated informative display, in accordance with one embodiment of the present invention.

FIG. 1B is a block diagram of storage device, in accordance with one embodiment of the present invention.

FIG. 2A is a representation of a display device is shown coupled to a storage device, in accordance with one embodiment of the present invention.

FIG. 2B is a block diagram of display device, in accordance with one embodiment of the present invention.

FIG. 3 depicts several representations of alternative embodiments of the present invention.

FIG. 4 is a block diagram of an exemplary computer system upon which embodiments of the present invention may be implemented.

FIG. 5 is a flowchart of a method for allowing for the display of information related to the contents of a storage device, in accordance with one embodiment of the present invention.

### DETAILED DESCRIPTION OF THE INVENTION

A method and system for an informative display on a storage device are disclosed. Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Notation and Nomenclature

Furthermore, in the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

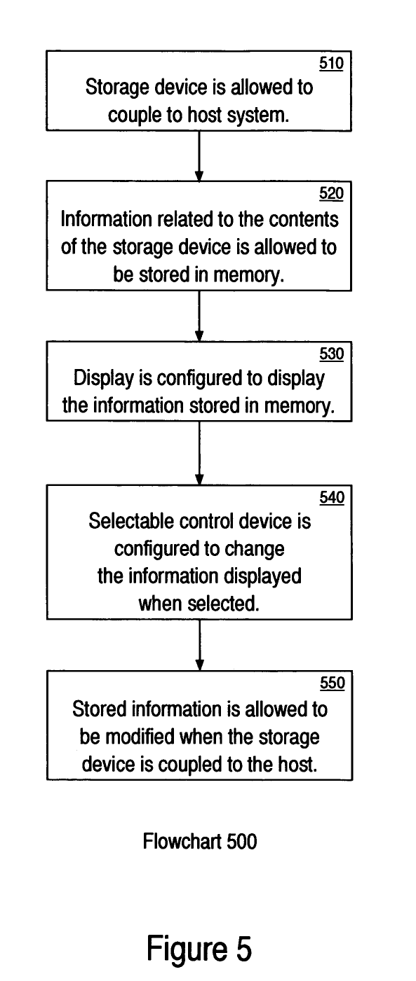

Portions of the detailed description that follows are presented and discussed in terms of a method. Although steps and sequencing thereof are disclosed in a figure herein (e.g., FIG. 5) describing the operations of this method, such steps and sequencing are exemplary. Embodiments of the present invention are well suited to performing various other steps or variations of the steps recited in the flowchart of the figure herein, and in a sequence other than that depicted and described herein.

Some portions of the detailed descriptions, which follow, are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “writing,” “including,” “testing,” “using,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Exemplary Computer System

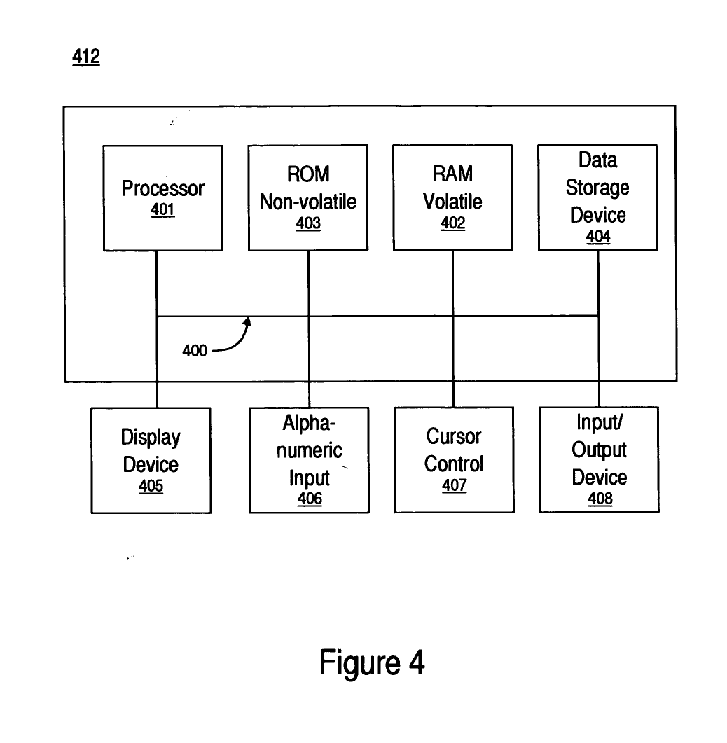

Referring now to FIG. 4, a block diagram of an exemplary computer system 412 is shown. It is appreciated that computer system 412 described herein illustrates an exemplary configuration of an operational platform upon which embodiments of the present invention can be implemented. Nevertheless, other computer systems with differing configurations can also be used in place of computer system 412 within the scope of the present invention. That is, computer system 412 can include elements other than those described in conjunction with FIG. 4. Moreover, the present invention may be practiced on any system which can be configured to allow it, not just computer systems like computer system 412.

Computer system 412 includes an address/data bus 400 for communicating information, a central processor 401 coupled with bus 400 for processing information and instructions; a volatile memory unit 402 (e.g., random access memory [RAM], static RAM, dynamic RAM, etc.) coupled with bus 400 for storing information and instructions for central processor 401; and a non-volatile memory unit 403 (e.g., read only memory [ROM], programmable ROM, flash memory, etc.) coupled with bus 400 for storing static information and instructions for processor 401. Computer system 412 may also contain an optional display device 405 coupled to bus 400 for displaying information to the computer user. Moreover, computer system 412 also includes a data storage device 404 (e.g., disk drive) for storing information and instructions.

Also included in computer system 412 is an optional alphanumeric input device 406. Device 406 can communicate information and command selections to central processor 401. Computer system 412 also includes an optional cursor control or directing device 407 coupled to bus 400 for communicating user input information and command selections to central processor 401. Computer system 412 also includes signal communication interface (input/output device) 408, which is also coupled to bus 400, and can be a serial port. Communication interface 408 may also include wireless communication mechanisms. Using communication interface 408, computer system 412 can be communicatively coupled to other computer systems over a communication network such as the Internet or an intranet (e.g., a local area network).

Structure of an Informative Display

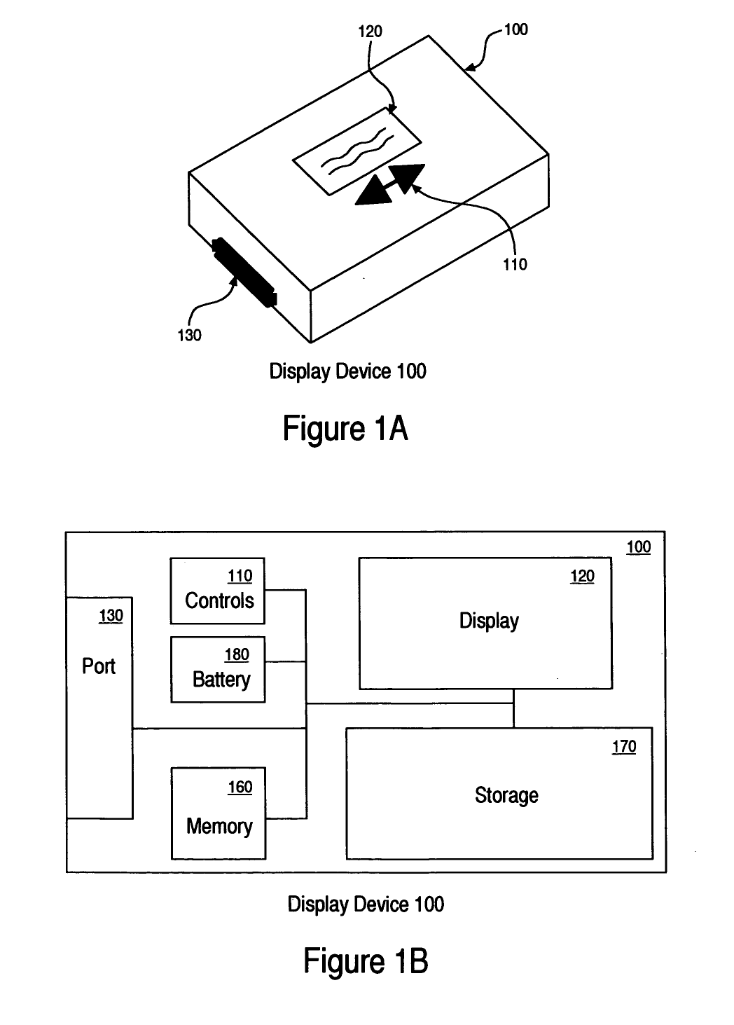

With reference now to FIG. 1A, a representation of a storage device with an integrated informative display is depicted, in accordance with one embodiment of the present invention. Storage device 100 is encased in housing 101. Storage device 100 is shown as having an integrated informative display 120. In this embodiment, display 120 is shown as a small liquid crystal display (LCD) unit, positioned on the upper surface of storage device 100. Other embodiments utilize other types of displays 120, or have them in alternate positions, as discussed below. Storage device 100 is also depicted with optional controls 110. Storage device 100 further includes port 130, for connecting storage device 100 with, e.g., a computing system or a media display device.

With reference now to FIG. 1B, a block diagram of storage device 100 is depicted, in accordance with one embodiment of the present invention. Storage device 100 is still depicted as including housing 101, display 120, optional controls 110, and port 130. Storage device 100 is also depicted as including memory 160. Storage device 100 also includes non-volatile storage 170. Storage device 100 is here depicted as including optional battery 180. Storage device 100 is shown as being communicatively coupled with system 199.

In one embodiment, storage device 100 is intended for use with system 199, where system 199 is a media center computer or digital video recorder (DVR). In this embodiment, storage device 100 is providing non-volatile storage for recorded media, such as recorded video. In this embodiment, storage device 100 is similar in size to a standard 3.5″ HDD. In one embodiment, non-volatile storage 170 is a modified 3.5″ HDD. In another embodiment, non-volatile storage 170 is a solid state digital storage, such as compact flash. Storage device 100, in this embodiment, is configured to allow for easy insertion and removal. When non-volatile storage 170 is full, or when a user wishes to use a different storage device, storage device 100 is of a size and shape that is easy to manipulate. Further, in this embodiment, storage device 100 is connected to system 199 at only one point, which allows for ease of removal and insertion. One factor in the development of this embodiment is that storage device 100 should be nearly as easy to use as a videocassette; the user should be able to have several storage devices 100, and switch between them at will.

Housing 101, in one embodiment, may be formed of plastic. In other embodiments, other materials may be used. Here, housing 101 includes an opening, allowing access to port 130. Port 130 is used to connect storage device 100 with system 199. Another embodiment includes a cover element, not shown, to prevent damage to port 130 when storage device 100 is not in use.

In one embodiment, when storage device 100 is connected to system 199, information is passed between system 199 and non-volatile storage 170 through port 130. In this embodiment, storage device 100 is transparent to system 199; e.g., system 199 communicates with non-volatile storage 170 exactly as it would if connected directly to a non-volatile storage of the same type as non-volatile storage 170, without storage device 100. In another embodiment, system 199 includes a device driver or other software to allow communication with storage device 100.

In one embodiment, storage device 100 includes display 120. Display 120, in this embodiment, is a liquid crystal display (LCD). In another embodiment, display 120 is a series of light-emitting diodes (LEDs). Other embodiments incorporate other types of display 120. Display 120, in this embodiment, is connected to memory 160. Memory 160 may be any type of rewritable storage; in one embodiment, memory 160 is a flash ROM; in another embodiment, memory 160 is a small-capacity compact flash storage.

In one embodiment, storage device 100 includes battery 180. Battery 180, in this embodiment, provides power to allow display 120 to display information when storage device 100 is not connected to system 199. In another embodiment, battery 180 provides power to controls 110. In another embodiment, battery 180 provides power to memory 160 when storage device 100 is not connected to system 199; in this embodiment, memory 160 is volatile memory. One embodiment calls for battery 180 to be an alkaline battery. Another embodiment calls for battery 180 to be a rechargeable battery. Other embodiments use other methods of energy storage. Still other embodiments omit battery 180 entirely.

In one embodiment, storage device 100 includes controls 110. In the depicted embodiment, controls 110 is shown as a scroll button. Other embodiments incorporate other types of controls 110, e.g., multiple separate buttons, rotating wheels, knobs, switches, or other desirable forms of interface. Other embodiments omit controls 110 entirely.

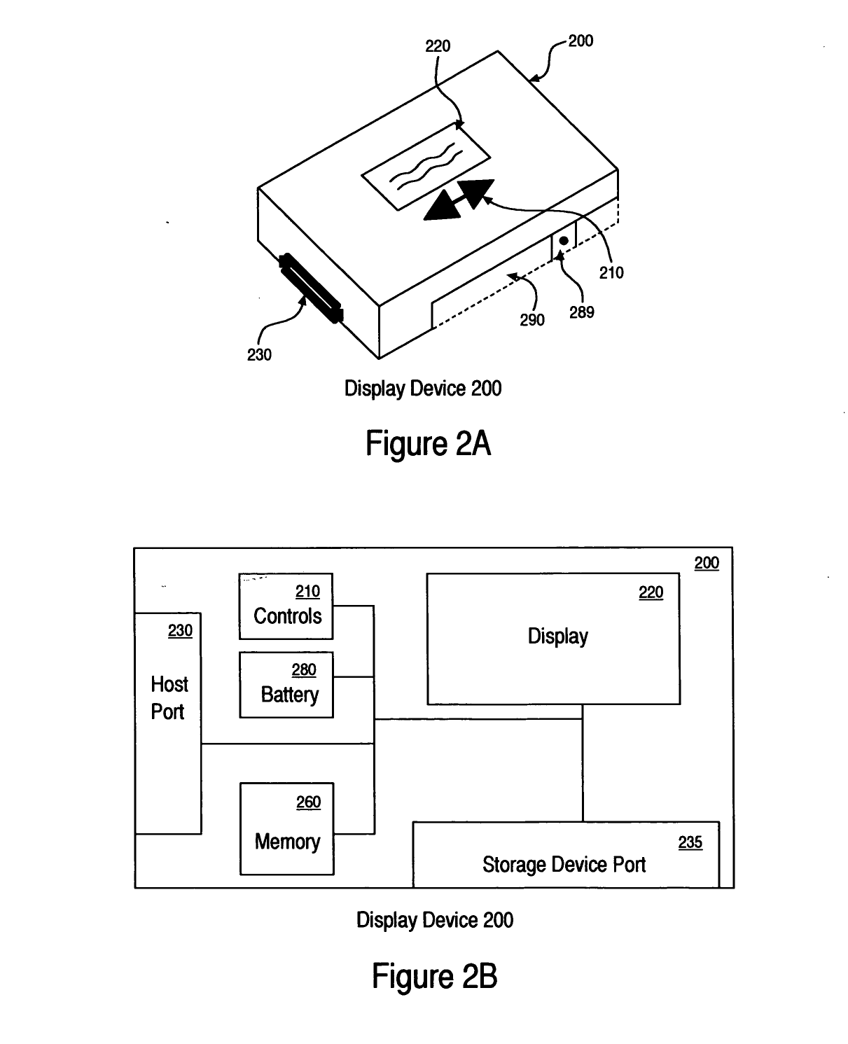

With reference now to FIG. 2A, a representation of a display device 200, coupled to a storage device 290, is shown, in accordance with one embodiment of the present invention. In this embodiment, display device 200 incorporates a housing 201, a display 220, and a port 230. This embodiment also depicts optional connection devices 289. In this embodiment, housing 201 is shaped so as to fit atop storage device 290, here a 3.51″ HDD. In other embodiments, housing 201 is shaped to conform to other form factor requirements, and to interface with other types of storage device 290. In one embodiment, for example, housing 201 defines a slot, into which storage device 290, a compact flash card, is inserted. In this embodiment, storage device 290 is held in place by connection devices 289, shown here as guide rails with screw holes appropriate to holding a 3.5″ HDD. Other embodiments use other forms of connection devices 289 appropriate to storage device 290. Other embodiments omit connection devices 289 entirely. In this embodiment, display 220 is shown as a small liquid crystal display (L CD) unit, positioned on the upper surface of display device 200. Other embodiments utilize other types of displays 220, or have them in alternate positions, as discussed below.

With reference now to FIG. 2B, a block diagram of display device 200 is shown, in accordance with one embodiment of the present invention. In one embodiment, display device 200 is similar to display device 100 in all particulars. In one embodiment, display device 200 further includes port 235. Port 235 couples with storage device 290. In different embodiments, port 235 conforms to different formats; e.g., in one embodiment, port 235 includes a standard ATA female jack, for coupling with a 3.5″ HDD; in another embodiment, port 235 includes a jack for coupling with a compact flash solid-state storage device. As with display device 100, embodiments of display device 200 may include a battery 280 or selectable controls 210; other embodiments omit these elements.

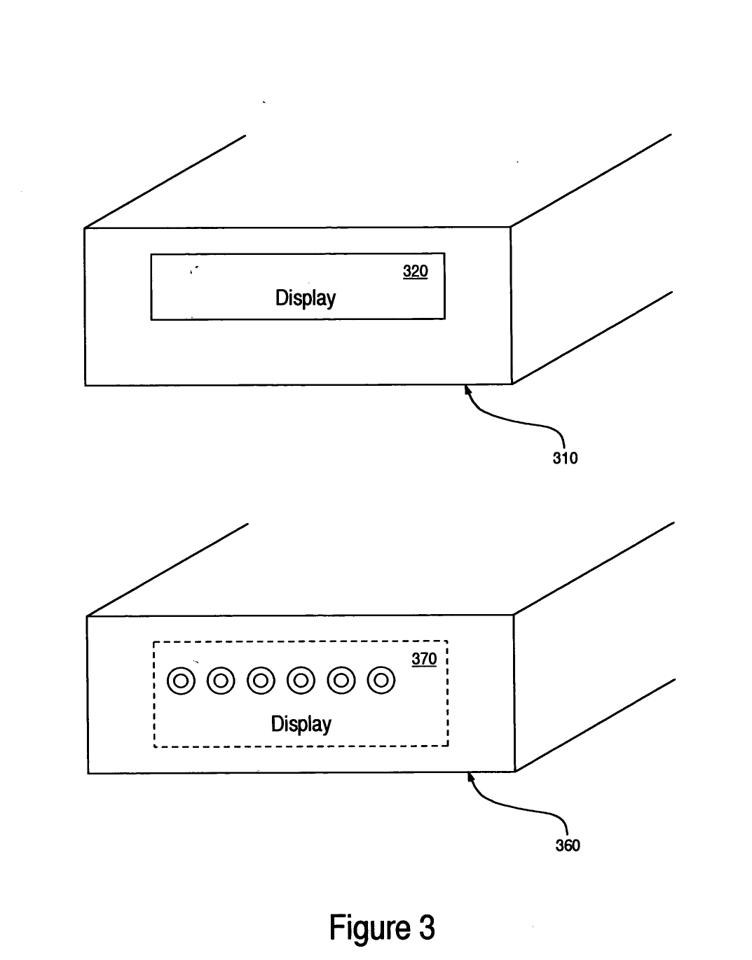

With reference now to FIG. 3, several alternative embodiments of the present invention are depicted. Display device 310 is shown, having a display 320 on one end of display device 310. Display 320 is shown here as being an LCD screen. Display device 360 is also shown, having a display 370 composed of a number of lights. In this embodiment, the array of lights that make up display 370 are an arrangement of light-emitting diodes (LEDs); other embodiments may use alternative light sources, or different arrangements of light sources, or different numbers of light sources.

Method of Displaying Information Related to the Contents of a Storage Device

With reference now to FIG. 5, a flowchart 500 of a method for allowing for the display of information related to the contents of a storage device is described, in accordance with one embodiment of the present invention. Although specific steps are disclosed in flowchart 500, such steps are exemplary. That is, embodiments of the present invention are well suited to performing various other (additional) steps or variations of the steps recited in flowchart 500. It is appreciated that the steps in flowchart 500 may be performed in an order different than presented, and that not all of the steps in flowchart 500 may be performed.

With reference now to step 510 and FIGS. 1B and 2B, a storage device is allowed to couple to a host system. In one embodiment, display device 100, which incorporates storage 170, couples to host system 199 through port 130. In another embodiment, storage device 290 connects to display device 200 at port 235, and display device 200 couples to host system 299 through port 230. In one embodiment, the host system includes an opening designed to receive the display device and storage device, e.g., a slot that display device 100 fits into, much like a videocassette loading into a video cassette recorder. In another embodiment, the storage device is connected to the host system with a cable. In another embodiment, the storage device incorporates a wireless communications device, and communicates with the host system wirelessly. In another embodiment, the storage device fits within a separate unit, housing multiple such storage devices, which is in turn coupled to the host system. Other embodiments allow for alternative methods of coupling the storage device with the host system.

The host system, in one embodiment, is a digital video recorder (DVR). In another embodiment, the host system is a computer system, such as computer system 412. In other embodiments, different host systems are selected.

With reference now to step 520 and FIGS. 1B and 2B, information related to the contents of the storage device is allowed to be stored on a memory device. In one embodiment, the information stored is the remaining capacity of the storage device; capacity may be measured in terms of percentage of capacity remaining, or as remaining free bytes, or as reflecting time, e.g., the storage device can hold 3 hours of additional stored video files, or in any other convenient manner. In another embodiment, the information stored is capacity presently used; this information could be reflected as a percentage of the total capacity, or as bytes currently used, or in terms of time, or in any other convenient manner. In another embodiment, this information could be user-inputted, allowing users to customize the information displayed. In another embodiment, the information displayed can be drawn from the storage device itself; e.g., names of files, or date a file was last accessed. In another embodiment, the information displayed can be drawn from an outside source over a network connection; e.g., the specific characteristics of a file can be compared to a stored database over an internet connection, to determine what the file is. Other embodiments allow for the display of other information.

In one embodiment, information is stored on the memory device through user action. For example, display device 100 is connected to host system 199, and a user uses software running on host system 199 to store the information in memory 160. In another embodiment, the information is automatically stored when the storage device is removed from the host system. For example, display device 200 is decoupled from system 299, and information regarding the files stored on storage device 290 is placed into memory 260 at that time. Other embodiments allow information to be stored on the memory device at other times.

With reference now to step 530 and FIGS. 1B, 2B, and 3, the display is configured to display the information stored, when the storage device is not coupled to the host system. The information to be displayed is drawn from the memory element; e.g., display device 200 extracts the information stored in memory 260 for display on display 220. How the information is displayed is contingent in part on the display element. In one embodiment, alphanumeric information may be displayed, when the display allows for alphanumeric characters. For example, display device 100 includes display 120, an LCD display, and can display alphanumeric characters, such as movie titles, dates, and capacity information; display device 360 includes display 370, an array of LEDs, and is limited to displaying information that may be expressed by a pattern of lit and unlit LEDs, such as remaining capacity of the storage device.

One important advantage to the present invention is that is allows a user to see the information related to the contents of the storage device when the storage device is not coupled to the host system. In one embodiment, a power source is incorporated into the display device, to provide power for the display when not connected to a host system. For example, display device 100 includes battery 180.

With reference now to optional step 540 and FIG. 1B, a selectable control device is configured to change the information displayed, when selected. Different embodiments may provide different controls, allowing for different functionality. In one embodiment, scrolling controls are provided, to allow a user to view more information than can be displayed at one time on the display. For example, display device 100 includes controls 110, which allows the user to scroll through several screens worth of text on display 120, such as a brief description of a movie stored in storage 170, or a list of files. In another embodiment, controls are provided to allow the user to alter the information displayed, such as changing the description of a file stored in the storage device. In another embodiment, a simple on/off control is provided, to allow the user to conserve power by not leaving the display always active. In another embodiment, controls are provided to change the type of information being displayed, such as from a list of files to the description of a single file, or to a display of remaining capacity on the storage device. Other embodiments incorporate selectable control devices to perform other functions, or combinations of functions.

By allowing for multiple screens worth of information, even information of different types, the present invention provides an advantage to the user. Rather than having to either write very small on the limited surface space of an adhesive label, the user is constrained only by the available controls and the size of the memory incorporated into the display. As such, the user may record paragraphs of information for each file stored, for dozens of files, without worrying that the information is illegible.

With reference now to optional step 550 and FIG. 1B, the information stored is allowed to be updated. This updating of the stored information can happen in different ways and at different times in different embodiments. In one embodiment, whenever the contents of the storage device change, the information stored in the memory is automatically updated. For example, when the contents of storage 170 change, as when a new file is recorded, memory 160 is automatically updated to reflect the new contents. In another embodiment, the user may manually update the information stored in memory. For example, when display device 100 is coupled to system 199, a user may use software operating on host system 199 to alter the description of a file in storage 170, and store those changes in memory 160. In other embodiments, other approaches to updating the information stored in memory are used.

Allowing for an easy method of updating the information displayed is also important, as it represents a significant advantage over handwritten labels. No messy crossing-out of obsolete information is required, nor do users have to cram additional information on an already-crowded adhesive label when a new file is recorded. Further, as the display can be integrated with the storage device, it is much less likely to be lost than a separate paper listing of the stored information would be, and much more likely to be updated than such a listing would be.

Embodiments of the present invention are thus described. While the present invention has been described in particular embodiments, it should be appreciated that the present invention should not be construed as limited by such embodiments, but rather construed according to the following claims.

What is claimed is:

1. A storage device with an integrated display for displaying information related to the contents of said storage device, said storage device comprising:
a housing;
a data storage element, disposed within said housing;
a display element, disposed within said housing, for displaying said information related to the contents of said storage device;
a memory, coupled to said display element, for storing said information related to the contents of said storage device; and
a port, coupled to said data storage element, configured to communicatively couple with a host system.

2. The storage device of claim 1, wherein said data storage element comprises a hard disk drive.

3. The storage device of claim 1, wherein said data storage element comprises a solid-state storage device.

4. The storage device of claim 1, further comprising a power storage element, for allowing said display element to display said information when not connected to said host system.

5. The storage device of claim 4, wherein said power storage element comprises an alkaline battery.

6. The storage device of claim 4, wherein said power storage element comprises a rechargeable battery.

7. The storage device of claim 1, wherein said display element comprises an alphanumeric display.

8. The storage device of claim 7, wherein said alphanumeric display comprises a liquid crystal display (LCD) screen.

9. The storage device of claim 1, where said display element comprises a plurality of light-emitting diodes (LEDs).

10. A display device for displaying information related to the contents of a storage device, said display device comprising:
a housing;
a display element, disposed within said housing, for displaying said information related to the contents of said storage device;
a memory, coupled to said display element, for storing said information related to the contents of said storage device;
a first port, disposed within said housing, configured to communicatively couple with a host system; and
a second port, disposed within said housing, configured to communicatively couple with said storage device.

11. The display device of claim 10, in which said display element comprises an alphanumeric display.

12. The display device of claim 11, in which said alphanumeric display comprises a liquid crystal display (LCD) screen.

13. The display device of claim 10, in which said display element comprises a plurality of light sources.

14. The display device of claim 10, in which said display device is configured to be removably coupled to said storage device.

15. The display device of claim 10, further comprising a power storage element, for allowing said display element to display said information when not connected to said host system.

16. The display device of claim 10, further comprising a selectable control mechanism, for selecting between a plurality of display modes of said display element.

17. A method for allowing for the display of information related to the contents of a storage device, said method comprising:
communicatively coupling said storage device to a host system;
retrievably storing information related to the contents of said storage device on a memory device; and
displaying said information related to the contents of said storage device, when said storage device is not coupled to said host system.

18. The method of claim 17, further comprising:
selecting a selectable control device such that said information displayed is changed.

19. The method of claim 18, wherein selecting said selectable control device causes the remaining capacity of said storage device to be displayed.

20. The method of claim 17, further comprising:
modifying said retrievably stored information when said storage device is coupled to said host system.
